(19) United States
(12) Patent Application Publication
(10) Pub. No.: US 2014/0229289 A1
(43) Pub. Date: Aug. 14, 2014

(54) ENHANCED SHARED SCREEN EXPERIENCES FOR CONCURRENT USERS

(71) Applicant: YAHOO! INC., Sunnyvale, CA (US)

(72) Inventors: Supreeth Hosur Nagesh Rao, Sunnyvale, CA (US); Shivakumar Ningappa, San Jose, CA (US); Sundeep Narravula, Sunnyvale, CA (US); Rahul Chugh, Santa Clara, CA (US)

(73) Assignee: YAHOO! INC., Sunnyvale, CA (US)

(21) Appl. No.: 13/766,553

(22) Filed: Feb. 13, 2013

(51) Int. Cl. G06Q 30/02

(52) U.S. Cl. CPC G06Q 30/0269
USPC 705/14.66

(57) ABSTRACT

In one embodiment, a group of two or more individuals may be identified. A group profile associated with the group of two or more individuals may be obtained. One or more content items and/or one or more advertisements suitable for presenting to the group of two or more individuals may be identified based, at least in part, upon the group profile. The one or more content items and/or one or more advertisements may be provided for access by the group of two or more individuals.

### BACKGROUND

The disclosed embodiments relate generally to methods and apparatus for enhancing shared device experiences for concurrent users.

Consumer electronic devices such as televisions, tablets, smartphones, and Blu-ray players are often shared by multiple individuals such as members of a family. In fact, content from these consumer electronic devices is often consumed at the same time by multiple individuals.

Today, many of the consumer electronic devices are Internet connected. Moreover, a majority of Internet applications and websites enable individual users to login to receive services such as streaming content, as well as suggestions for content that might appeal to the individual users. Unfortunately, the content and suggestions provided by these services may not be suitable for viewing by all of the individuals concurrently using these devices. Similarly, the content and suggestions provided by these services may not appeal to all of the individuals concurrently consuming the content.

### SUMMARY

The disclosed embodiments enable content and/or advertisements to be customized for a group of individuals concurrently accessing a shared device. In one embodiment, a group of two or more individuals may be identified. A group profile associated with the group of two or more individuals may be obtained. One or more content items and/or one or more advertisements suitable for presenting to the group of two or more individuals may be identified based, at least in part, upon the group profile. The one or more content items and/or one or more advertisements may be provided for access by the group of two or more individuals.

Various embodiments may be implemented via a device comprising a processor, memory, and a display. The processor and memory are configured to perform one or more of the above described method operations. Other embodiments may be implemented via a computer readable storage medium having computer program instructions stored thereon that are arranged to perform one or more of the above described method operations.

These and other features and advantages of the disclosed embodiments will be presented in more detail in the following specification and the accompanying figures which illustrate by way of example the principles of the disclosed embodiments.

### BRIEF DESCRIPTION OF THE DRAWINGS

FIG. 1 is a diagram illustrating an example system in which various embodiments may be implemented.

FIG. 2 is an example graphical user interface that may be implemented to establish a group of individuals consuming content via a shared screen in accordance with various embodiments.

FIG. 3 is an example graphical user interface that may be implemented to view or modify group information pertaining to a particular group in accordance with various embodiments.

FIG. 4 is a process flow diagram illustrating an example method of providing content and/or advertisements to a group of individuals in accordance with various embodiments.

FIG. 5 is a block diagram illustrating an example system in which various embodiments may be implemented.

FIG. 6 is a schematic diagram illustrating an example embodiment of a network in which various embodiments may be implemented.

FIG. 7 is a schematic diagram illustrating an example client device that may operate as a shared device in accordance with various embodiments.

FIG. 8 is a schematic diagram illustrating an example computer system in which various embodiments may be implemented.

### DETAILED DESCRIPTION OF THE SPECIFIC EMBODIMENTS

Reference will now be made in detail to specific embodiments of the disclosure. Examples of these embodiments are illustrated in the accompanying drawings. While the disclosure will be described in conjunction with these specific embodiments, it will be understood that it is not intended to limit the disclosure to these embodiments. On the contrary, it is intended to cover alternatives, modifications, and equivalents as may be included within the spirit and scope of the disclosure as defined by the appended claims. In the following description, numerous specific details are set forth in order to provide a thorough understanding of the disclosure. The disclosed embodiments may be practiced without some or all of these specific details. In other instances, well known process operations have not been described in detail in order not to unnecessarily obscure the disclosure. The Detailed Description is not intended as an extensive or detailed discussion of known concepts, and as such, details that are known generally to those of ordinary skill in the relevant art may have been omitted or may be handled in summary fashion.

Subject matter will now be described more fully hereinafter with reference to the accompanying drawings, which form a part hereof, and which show, by way of illustration, specific example embodiments. Subject matter may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware or any combination thereof (other than software per se). The following detailed description is, therefore, not intended to be taken in a limiting sense.

Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of example embodiments in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

Example System

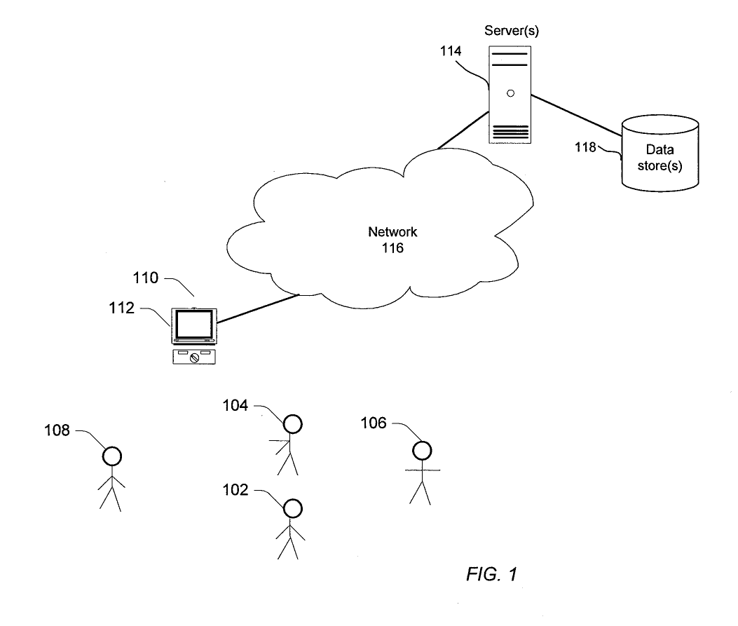

FIG. 1 is a diagram illustrating an example system in which various embodiments may be implemented. Multiple individuals (i.e., users) 102, 104, 106, 108 may concurrently consume content and/or advertisements provided via the same, shared device 110. The device 110 that is shared by the multiple individuals may be a device such as a television, computer (e.g., desktop, laptop, tablet, etc.), media computing platform (e.g., cable and satellite set top boxes), handheld computing device (e.g., PDAs), cell phone, or any other type of computing or communication platform. In some implementations, the multiple individuals may consume content and/or advertisements rendered on the same screen 112, which may be a screen of the shared device 110.

In the following description, the multiple individuals 102, 104, 106, 108 consuming content and/or advertisements on the shared device 110 or shared screen 112 may be referred to as a group of individuals. Although four individuals are shown in this example, any number of individuals may concurrently consume content on the shared device 110 or shared screen 112. Therefore, the group of individuals may include two or more individuals.

The content and/or advertisements that is consumed by the group of individuals may include, but is not limited to, images (e.g., drawings, tables, diagrams, photographs), text, videos (e.g., television programs, movies), and/or audio (e.g., songs, recorded books). Accordingly, the manner of consumption of the content and/or advertisements may include viewing the content and/or listening to the content.

In some instances, the group of individuals may be of different ages and/or mental capabilities. As a result, it may be desirable to target the content and/or advertisements to the group rather than specific individuals. This may be accomplished via a group targeting system such as that described below.

The group targeting system may include one or more servers 114, which may include at least one web server associated with a web site such as a social networking web site. Examples of social networking web sites include Yahoo, Facebook, Tumblr, LinkedIn, Flickr, and Meme. The server(s) 114 may enable the web site to provide a variety of services to its users. More particularly, users of the web site may create, activate, update, delete, deactivate, or otherwise change individual user accounts, group accounts, private or public user profiles, interact with other members of the web site, upload files (e.g., photographs, videos), purchase goods or services, access information posted on the web site, etc.

In this example, the server(s) 114 may obtain or otherwise receive data (e.g., group or individual account data and/or group or individual profile data) and/or requests (e.g., search requests or account requests pertaining to a particular individual or group account). Requests include requests sent via a network 116 such as the Internet from a computer or shared device 110 in association with one of the individuals 102-108 or a group of individuals, respectively. For example, each of the entities 102-108 may be an individual such as a user of the web site or an individual operating within or on behalf of a group of individuals.

The server(s) 114 may have access to one or more data stores 118, which may include one or more memories. More particularly, the data stores 118 may include user logs that store individual user profiles and/or individual user accounts. Similarly, the data stores 118 may include group logs that store group profiles and/or group accounts.

The server(s) 114 may include one or more ad servers and/or one or more content servers. The ad server(s) may customize advertisements for targeting to individuals and/or group(s) of users. Similarly, the content server(s) may customize content for targeting to individuals and/or group(s) of users. Specific mechanisms for implementing group targeting of advertisements and content will be described in further detail below.

An individual user account may pertain to goods or services provided to the user and/or goods or services that are available to the user. Similarly, a group account may pertain to goods or services provided to a particular group and/or goods or services that are available to the group. The user account or group account may be managed by a company that provides goods or services or another entity such as an Internet Services Provider.

Individual and/or group account information retained in the data stores 118 may include identification information that may be used to identify and/or authenticate individual users or individuals within a group. For example, the identification information may include, but is not limited to, digital information identifying facial features, digital fingerprint information, digital voice information, an identifier such as a username or an electronic mail address, a passcode, a password, and/or a pattern. The account information may further include personal information such as demographic information (e.g., age and/or gender) and/or geographic information (e.g., residence address, work address, and/or zip code). Moreover, the account information may include financial information such as credit card information, enabling goods or services provided in association with the account to be purchased. In addition, the account information may include information pertaining to goods or services that are available to, or used by, an individual or group via the individual or group account. More particularly, the account information may indicate an amount and/or quality of the goods or services that are available or that have been used. In addition, the account information may indicate a cost associated with the amount and/or quality of goods or services that are available or used.

The account information may also include or be linked to additional information pertaining to the account, such as user information or group information. For example, the server(s) 114 may have access to additional user information and/or group information stored in the data stores 118. For example, the user information may be retained in one or more user logs. This user information or a portion thereof may be referred to as a user profile. More particularly, the user profile may include public information that is available in a public profile and/or private information. Furthermore, the user profile may include information that has been submitted by the user and/or information that has been deduced or automatically collected by the system (e.g., based upon user action(s)).

The user information retained in the user logs may include personal information such as demographic information (e.g., age and/or gender) and/or geographic information (e.g., residence address, work address, and/or zip code). In addition, each time a user performs online activities such as clicking on an advertisement, purchasing goods or services, posting information or content (e.g., on a web site or within the user's public profile), or annotating content, information regarding such activity or activities may be retained as user data in the user logs. For instance, the user data that is retained in the user logs may indicate the identity of web sites visited, identity of ads that have been selected (e.g., clicked on), content viewed or selected, and/or a timestamp. Moreover, where the online publisher supports a search engine (e.g., via the server 114 or a separate search server), information associated with a search query, such as search term(s) of the search query, information indicating characteristics of search results that have been selected (e.g., clicked on) by the user, and/or associated timestamp may also be retained in the user logs. A user may be identified in the user logs by a user token or identifier (e.g., user account ID), information in a user cookie, etc.

Similarly, group information may be retained in one or more group logs. This group information or a portion thereof may be referred to as a group profile. More particularly, the group profile may include public information that is available in a public group profile, a public individual profile, and/or private information from a private individual profile or a private group profile. The group profile may include information that has been submitted by the individual(s) of the group and/or information that has been deduced or automatically collected by the system (e.g., based upon activities such as online activities of the group and/or individuals in the group).

The group information retained in the group logs may include demographic information (e.g., age and/or gender) for a group and/or geographic information (e.g., residence address, work address, and/or zip code) for the group. In addition, each time the group performs online activities such as clicking on an advertisement, purchasing goods or services, posting information or content (e.g., on a web site or within the user's public profile), or annotating content, information regarding such activity or activities may be retained as group data in the group logs. For instance, the group data that is retained in the user logs may indicate the identity of web sites visited, identity of ads that have been selected (e.g., clicked on), content that has been viewed or selected, and/or a timestamp. Moreover, where the online publisher supports a search engine (e.g., via the server 114 or a separate search server), information associated with a search query, such as search term(s) of the search query, information indicating characteristics of search results that have been selected (e.g., clicked on) by the group, and/or associated timestamp may also be retained in the group logs. A group may be identified in the group logs by a group token, which may identify the individuals in the group. For example, the group token may be generated based, at least in part, upon individual identifiers, account identifiers, and or cookies.

In one embodiment, as an individual (or group) interacts with a software application, e.g., an instant messenger or electronic mail application, descriptive content such as, for example, an email address, instant messenger identifier, phone number, postal address, message content, date, time, etc., may be identified and stored. Descriptive content may be stored along with contextual content. For example, how a phone number came to be identified (e.g., it was contained in a communication received from another via an instant messenger application) may be stored as contextual content associated with the phone number. Contextual content, therefore, may identify circumstances surrounding receipt of a phone number (e.g., date or time the phone number was received) and may be associated with descriptive content. Contextual content, may, for example, be used to subsequently search for associated descriptive content. For example, a search for phone numbers received from specific individuals, received via an instant messenger application or at a given date or time, may be initiated.

Content within a repository of media or multimedia, for example, may be annotated. Examples of content may include text, images, audio, video, or the like, which may be processed or stored in memory. Content may be contained within an object, such as a Web object, Web page, Web site, electronic document, or the like. An item in a collection of content may be referred to as an “item of content” or a “content item,” and may be retrieved from a “Web of Objects” comprising objects made up of a variety of types of content. The term “annotation,” as used herein, refers to descriptive or contextual content related to a content item, for example, collected from a group, an individual, such as a user, and stored in association with the group, the individual, and/or the content item. Annotations may include various fields of descriptive content, such as a rating of a document, a list of keywords identifying topics of a document, etc.

A profile builder may initiate generation of a profile, such as for users (or groups of users) of an application, including a search engine, for example. A profile builder may initiate generation of a user profile (or group profile) for use, for example, by a user or group of users, as well as by an entity that may have provided the application. For example, a profile builder may enhance relevance determinations and thereby assist in indexing, searching or ranking search results. Therefore, a search engine provider may employ a profile builder, for example.

A variety of mechanisms may be implemented to generate a profile including, but not limited to, collecting or mining navigation history, stored documents, tags, or annotations, to provide a few examples. A profile builder may store a generated profile. Through the use of user profiles (and/or group profiles) of a search engine, for example, a search engine provider may to retrieve annotations, tags, stored pages, navigation history, or the like, which may be useful for making relevance determinations of search results, such as with respect to a particular user or group of users.

Advertising

Various monetization techniques or models may be used in connection with sponsored search advertising, including advertising associated with user search queries, or non-sponsored search advertising, including graphical or display advertising. In an auction-type online advertising marketplace, advertisers may bid in connection with placement of advertisements, although other factors may also be included in determining advertisement selection or ranking. Bids may be associated with amounts advertisers pay for certain specified occurrences, such as for placed or clicked-on advertisements, for example. Advertiser payment for online advertising may be divided between parties including one or more publishers or publisher networks, one or more marketplace facilitators or providers, or potentially among other parties.

Some models may include guaranteed delivery advertising, in which advertisers may pay based at least in part on an agreement guaranteeing or providing some measure of assurance that the advertiser will receive a certain agreed upon amount of suitable advertising, or non-guaranteed delivery advertising, which may include individual serving opportunities or spot market(s), for example. In various models, advertisers may pay based at least in part on any of various metrics associated with advertisement delivery or performance, or associated with measurement or approximation of particular advertiser goal(s). For example, models may include, among other things, payment based at least in part on cost per impression or number of impressions, cost per click or number of clicks, cost per action for some specified action(s), cost per conversion or purchase, or cost based at least in part on some combination of metrics, which may include online or offline metrics, for example.

Ad Networks/Exchanges

A process of buying or selling online advertisements may involve a number of different entities, including advertisers, publishers, agencies, networks, or developers. To simplify this process, organization systems called “ad exchanges” may associate advertisers or publishers, such as via a platform to facilitate buying or selling of online advertisement inventory from multiple ad networks. “Ad networks” refers to aggregation of ad space supply from publishers, such as for provision en masse to advertisers.

Ad Targeting

For web portals like Yahoo!, advertisements may be displayed on web pages resulting from a user-defined search based at least in part upon one or more search terms. Advertising may be beneficial to users, advertisers or web portals if displayed advertisements are relevant to interests of one or more users. Thus, a variety of techniques have been developed to infer user interest, user intent or to subsequently target relevant advertising to users.

One approach to presenting targeted advertisements includes employing demographic characteristics (e.g., age, income, sex, occupation, etc.) for predicting user behavior, such as by group. Advertisements may be presented to users in a targeted audience based at least in part upon predicted user behavior(s).

Another approach includes profile-type ad targeting. In this approach, user profiles specific to a user may be generated to model user behavior, for example, by tracking a user's path through a web site or network of sites, and compiling a profile based at least in part on pages or advertisements ultimately delivered. A correlation may be identified, such as for user purchases, for example. An identified correlation may be used to target potential purchasers by targeting content or advertisements to particular users.

Ad Serving

An “ad server” comprises a server that stores online advertisements for presentation to users. “Ad serving” refers to methods used to place online advertisements on websites, in applications, or other places where users are more likely to see them, such as during an online session or during computing platform use, for example.

Ad Analytics

During presentation of advertisements, a presentation system may collect descriptive content about types of advertisements presented to users. A broad range of descriptive content may be gathered, including content specific to an advertising presentation system. Advertising analytics gathered may be transmitted to locations remote to an advertising presentation system for storage or for further evaluation. Where advertising analytics transmittal is not immediately available, gathered advertising analytics may be stored by an advertising presentation system until transmittal of those advertising analytics becomes available.

An online publisher (i.e., web publisher) will generally be responsible for delivering multiple advertisements via the Internet (or other communication media such as email, text message, or digital television). A contract agreement associated with a particular advertisement may specify a minimum number of page views (i.e., impressions) to be delivered within a particular period of time. The web publisher is therefore responsible for providing the requested number of impressions for each advertisement.

The contract agreement may further specify a desired profile of users and/or groups that are to receive the requested number of impressions. The desired profile may indicate a set of desired characteristics of individuals that are to receive the impressions. Similarly, the desired profile may indicate a set of desired characteristics of groups that are to receive the impressions.

In some embodiments, the contract agreement may indicate that a specified number or percentage of the requested number of impressions is to be satisfied by groups of individuals (rather than individual users). Since a single impression provided to a group of individuals may have a greater impact, a different pricing schedule may be associated with providing impressions to groups than the pricing schedule associated with providing impressions to individuals.

In accordance with various embodiments, the system may store a plurality of advertisements. An online publisher agrees to provide the advertisements to users or groups in accordance with the corresponding contract agreement(s) and desired profile(s). Such agreements may be generated in response to auctioning of specific group and/or user profiles to advertisers.

An advertisement may include content pertaining to a product or service, which may be delivered via the Internet, email, text message, or digital television. The content typically includes text. However, it is important to note that an advertisement may include text, one or more images, video, and/or audio. An advertisement may also include one or more hypertext links, enabling a user (or group) to proceed with the purchase of a particular product or service.

The disclosed embodiments enable content items and/or advertisements to be identified, selected, generated, transmitted, and/or otherwise provided to users and/or groups of users based, at least in part, upon characteristics of the individuals and/or groups. More particularly, the server(s) 114 may provide content and/or advertisements to the users or groups via the web site (e.g., via display on a web page of the web site), via electronic mail, Short Message Service (SMS), via a handheld computing device (e.g., text message), via an application executing on a shared device, or via another medium such as digital television, which may be connected to the Internet. For example, an advertisement may be provided to in the form of a pop-up window.

A content item or advertisement may be provided to a particular user or group in a variety of contexts. In some implementations, the server(s) 114 may provide the content item or advertisement independent from other content being consumed by the user or group. In some other implementations, the server(s) 114 may provide the content or item in association with additional content being consumed by the user or group. Such additional content may be provided to the user or group by the server(s) or by another network device. The content item or advertisement may be rendered individually on the shared device. Alternatively, the content item or advertisement may be rendered such that it overlays or otherwise supplements additional content being rendered to the shared device. For example, the content item or advertisement may be rendered such that it is placed, at least in part, within or among the additional content, adjacent to the additional content, underlying the additional content, and/or overlaying the additional content.

Where a content item or an advertisement is provided to a particular user or group, information pertaining to the content item or advertisement (e.g., identifying a product or service advertised in the advertisement) may be stored in association with a user's profile and/or a group's profile. In addition, the server(s) 114 may automatically collect online (and/or real world) behavioral data for any of users 102-108 and/or groups of users to determine whether the advertisement was successful. In other words, the server(s) 114 may determine whether the user (or group of users) purchased the product or service advertised in the advertisement. For example, the server(s) 114 may determine whether a content item is subsequently downloaded or purchased. Data indicating whether the advertisement was successful may also be stored in association with the user profile, the group profile, and/or the advertisement. Therefore, data indicating whether a content item is accessed or purchased may also be stored in association with the user profile and/or group profile.

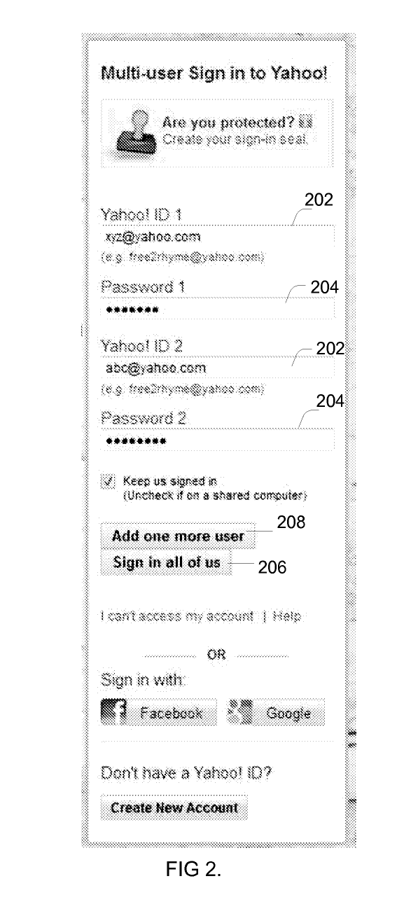

A group of individuals may be identified or established based, at least in part, upon an identifier of each of the individuals in the group. FIG. 2 is an example graphical user interface that may be implemented to identify or establish a group of individuals consuming content via a shared device or shared screen in accordance with various embodiments. Each of the individuals may be identified via identification information that may be used to uniquely identify and/or authenticate the individuals. For example, the identification information may include, but is not limited to, digital information identifying facial features, digital fingerprint information, digital voice information, an identifier such as a username or an electronic mail address, a passcode, a password, and/or a pattern. An identification mechanism may be configured for recognizing and/or authenticating the identification information of each of the individuals. Such an identification mechanism may be configured to perform operations such as facial recognition, voice recognition, fingerprint recognition, recognition of an identifier such as a username or electronic mail address, and/or recognition of a passcode, password and/or pattern. As shown in this example, the identification information for each of the individuals may include an electronic mail address 202 and a password 204. More particularly, in this example, the electronic mail address 202 and password 204 are submitted for two different individuals. Through the use of the identification information of each of the individuals, the system may authenticate the individuals. The group may be signed in to the system as a group entity via a group account, which may be accomplished by clicking on a “sign in” icon or button as shown at 206.

Group membership of individuals consuming content via a shared device or shared screen may be dynamic. More particularly, all members of the group need not sign in at the same time via the same graphical user interface. Rather, an individual may be added to the group at a later time, as shown at 208. More particularly, the individual may be identified and/or authenticated based upon identification information associated with the individual. For example, the individual may be identified by an electronic mail address, and may be authenticated via a password. Similarly, members of the group may leave the group at different points in time, which may involve logging out of the system by or on behalf of the individual(s) leaving the group. Therefore, individuals may join or leave the group at different points in time.

A group may be identified by a group token that identifies all of the individuals in the group. For example, the group token may be generated, at least in part, based upon a token (e.g., cookie) associated with each of the individuals in the group. Thus, when an individual joins an existing group, another group token may be assigned or obtained to include the additional individual. Similarly, when an individual leaves a group, another group token may be assigned or obtained to reflect the individuals that are currently consuming the content via the shared device or shared screen.

The group token may be associated with information from at least one user profile of each of the individuals in the group. As a result, the group token may be associated with characteristics of each of the individuals in the group. Thus, the group token may be associated with a set of characteristics representing the group. In some implementations, the set of characteristics may represent the “common denominator” of the group. For example, where one of the group members is under 21, the “common denominator” may indicate that all members of the group are not over 21.

In various embodiments, the group token may be associated with a group profile. The group profile may include group information pertaining to each of the individuals and/or the group as a whole. More particularly, the group profile may indicate, include, or be associated with a set of one or more targeting rules for identifying content and/or advertisements suitable for presenting to the group. For example, where one of the group members is under 21, the set of targeting rules may indicate that advertisements for liquor should not be presented to this particular group. As another example, where one of the group members is under 13, the set of targeting rules may indicate that no content inappropriate for age 12 such as violent advertisements should be presented to the group.

In addition, the group profile may indicate, include, or be associated with a set of one or more privacy rules for providing content addressed to a single individual in the group to the entire group of two or more individuals. The set of privacy rules may pertain to data or files such as electronic mail messages, text messages, voice mail messages, services such as content streaming services, and/or content such as movies. For example, the set of privacy rules may indicate that electronic mail messages directed to any of the individuals in the group should not be presented to the group. As another example, the set of privacy rules may indicate that electronic mail messages directed to an individual under 13 should be presented to the group, but electronic mail messages directed to individuals 13 or older should not be presented to the group.

In some implementations, the group token may be associated with a login context. More particularly, the login context may indicate contextual information such as a time of day, day of the week, time of year, and/or location in which the shared device 110 is being accessed. Thus, the set of targeting rules and/or the set of privacy rules applicable to a particular group may vary according to the login context.

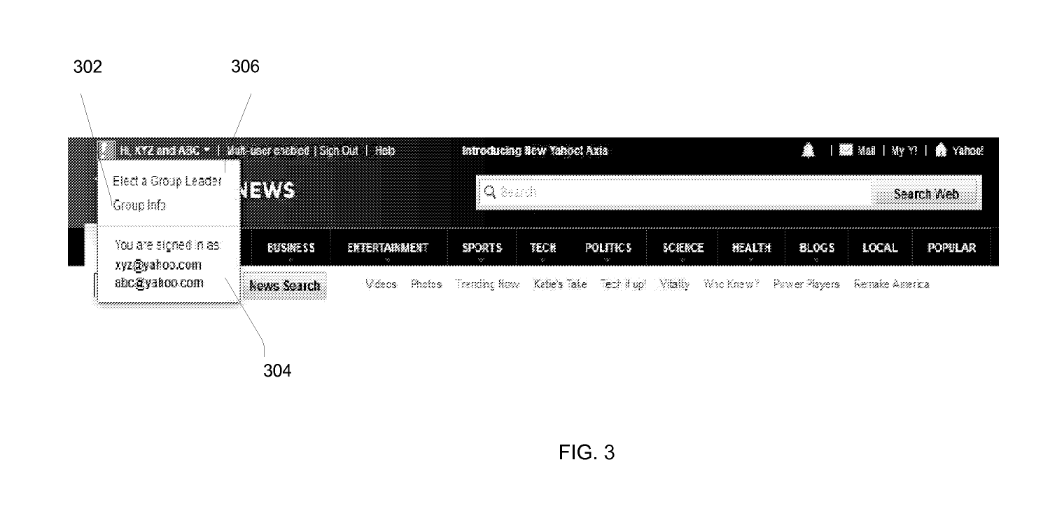

FIG. 3 is an example graphical user interface that may be implemented to view or modify group information pertaining to a particular group in accordance with various embodiments. More particularly, the group may view characteristics, rules (e.g., targeting and/or privacy rules), preferences, and/or other information pertaining to the group. For example, this may be accomplished by selecting “group information” pertaining to the group at 302. The group may be identified by the group members of the group at 304. More particularly, the group may be identified by identifiers of the individuals that are signed in as members of the group. The group information may indicate or identify each of the individuals in the group, characteristics of each of the individuals in the group and/or the group as a whole (e.g., the common denominator), targeting rules for identifying content and/or advertisements suitable for presenting to the group, privacy rules, preferences of the group, and/or other information.

In addition, a group account associated with the group token may be established. As a result, individuals within the group may configure group account settings. More particularly, group preferences of the group may be indicated or specified such that the group preferences are associated with the group token. For example, the group preferences may indicate or specify one or more desired privacy rules and/or one or more desired targeting rules for identifying content and/or advertisements for presentation to the group. For example, the group preferences may indicate that this particular group enjoys Disney movies. As another example, the group preferences may indicate that this particular group does not wish electronic mail messages to be presented to the group, but would like to receive electronic mail message notifications.

In some embodiments, the group preferences may be indicated or specified by a group leader. In this example, the group leader may be elected as shown at 306. The group leader may be elected by selecting or entering identification information such as an identifier of one of the individuals in the group. In addition, the group leader may enter identification information such as an identifier and a password for purposes of viewing and/or modifying the group preferences.

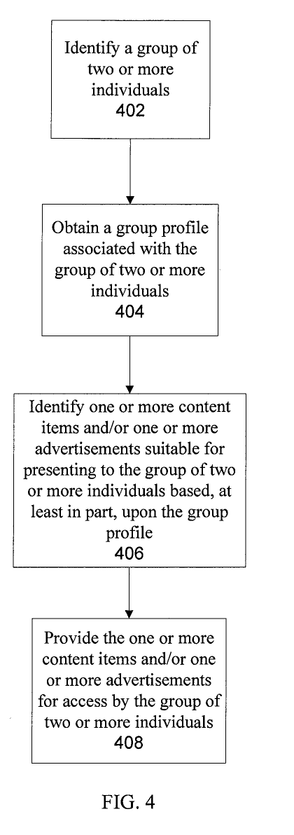

FIG. 4 is a process flow diagram illustrating an example method of providing content and/or advertisements to a group of individuals in accordance with various embodiments. A group of two or more individuals may be identified at 402. More particularly, the group of two or more individuals may concurrently consume content and/or advertisements via a shared device. In some implementations, the group of two or more individuals may concurrently consume content and/or advertisements via a shared screen of a shared device.

The group of two or more individuals may be identified by obtaining or generating a group token associated with the group of two or more individuals. More particularly, the group token may be generated based, at least in part, upon a token (e.g., identifier or cookie) of each of the two or more individuals in the group. The group token may be obtained or generated upon receiving identification information associated with each of the two or more individuals in the group. For example, the identification information may include an identifier such as an electronic mail address and/or a password.

In some implementations, each of the individuals may be authenticated through the use of corresponding identification information, such as an identifier and password. In addition, at least one user profile associated with each of the individuals may be identified and retrieved through the use of the corresponding identification information.

A group profile associated with the group of two or more individuals may be obtained at 404. More particularly, the group profile associated with the group token may be identified and retrieved. Alternatively, the group profile may be generated and associated with the group token. In some embodiments, the group profile may be generated, at least in part, from at least one user profile of each of the two or more individuals in the group of two or more individuals. The group profile may indicate characteristics of each of the individuals in the group and/or the group as a whole. For example, the group profile may define the common denominator of the group (e.g., the youngest individual in the group is 12). As another example, the group profile may indicate group characteristics such as demographics of the group, interest(s) of the group, and/or preference(s) of the group. Demographics may indicate age, gender, income, profession, and/or geographic information (e.g., zip code, area code, city, state, country, etc.).

In addition, the group profile may indicate, include, or be associated with a targeting profile and/or a set of targeting rules for identifying content and/or advertisements suitable for presentation to the group. Similarly, the group profile may indicate, include, or be associated with a privacy profile and/or a set of privacy rules for presenting content addressed to a particular individual to the entire group. In some instances, the group profile, targeting profile, set of targeting rules, privacy profile, and/or set of privacy rules may be generated or modified according to a set of group preferences associated with the group. More particularly, a set of group preferences may be received via a graphical user interface from one or more of the individuals in the group. For example, the set of group preferences may be indicated, selected, or specified by a group leader of the group. Alternatively, the group profile, targeting profile, set of targeting rules, privacy profile, and/or set of privacy rules may be generated according to a set of default preferences. For example, the default preferences may indicate that violent advertisements should not be shown to individuals under 13 years of age.

The group profile may be generated, modified or retrieved as individuals join or leave the group. More particularly, when an indication that an individual is leaving or joining the group is received, a new group profile may be generated or retrieved to reflect the current membership of the group. For example, group profile I may be associated with a first group including members A, B, and C, while group profile II may be associated with a second group including members A and C. Where members A and C have logged in as a group to view the same screen, group profile II may be generated or retrieved. After individual B joins them and has been logged in as a member of the group, group profile I may be generated or retrieved.

One or more content items and/or one or more advertisements suitable for presenting to the group of two or more individuals may be identified at 406 based, at least in part, upon the group profile. For example, the targeting profile and/or set of targeting rules pertaining to the group of two or more individuals may be applied to identify one or more content items and/or one or more advertisements. In addition, the privacy profile and/or set of privacy rules may limit the content items that are suitable for viewing by the group.

The one or more content items and/or one or more advertisements may be provided at 408 for access by the group of two or more individuals. More particularly, the one or more content items and/or one or more advertisements may be transmitted to the group of two or more individuals via a shared device. Accordingly, the content items and/or advertisements may be rendered via a shared screen of the shared device.

Behavior of the group of two or more individuals may be tracked and characteristics of the behavior of the group of two or more individuals may be recorded. Such characteristics may be used to improve system performance by refining the set of rules for identifying content and/or advertisements suitable for presenting to the group of two or more individuals. Accordingly, the content and/or advertisements suitable for presenting to the group of two or more individuals may be identified, at least in part, upon the characteristics of the behavior of the group of two or more individuals.

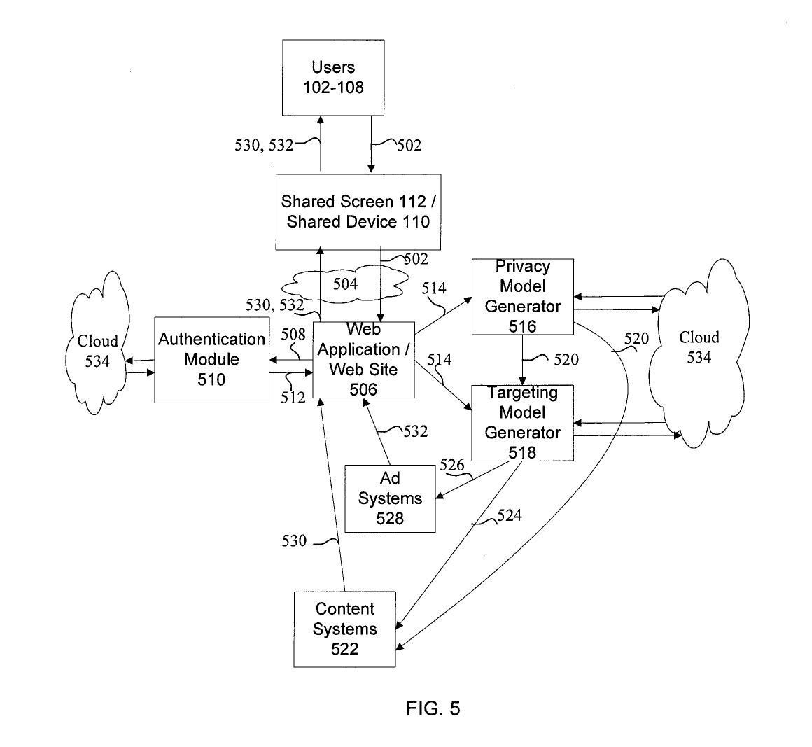

FIG. 5 is a block diagram illustrating an example system in which various embodiments may be implemented. As shown in FIG. 5, two or more individuals 102-108 concurrently accessing the shared device 110 or, more particularly, the shared screen 112 of the shared device 110, may submit identification information (e.g., login information) at 502 via the shared device 110 over the Internet 504 to login to a group account via a web application executing on a web site 506. As set forth above, the identification information for each of the individuals may include an identifier such as a username or electronic mail address and/or a password. The identification information for each of the individuals 102-108 may be provided at 508 to an identification mechanism such as authentication module 510. More particularly, at any point in time, the authentication module 510 may accept the identification information for one or more individuals from the web application or the web site 506. The authentication module 510 may authenticate the identification information for each of the individuals 102-108. This may be accomplished, for example, by accessing individual user profiles of the individuals 102-108 (e.g., via cloud 534). More particularly, each of the user profiles may include or otherwise be associated with the corresponding identification information. For example, the identification information may include, but is not limited to, facial features, fingerprint information, digital voice information, an identifier such as a username or an electronic mail address, a passcode, a password, and/or pattern.

Upon authenticating each of the individuals, the authentication module 510 may obtain or generate a group token 512 for use in identifying a group including the individuals 102-108. The group token 512 may uniquely identify the individuals 102-108 in the group. In addition, in some implementations, the group token 512 may also identify a particular session for the group. Thus, the group token may indicate the login context, where the login context indicates contextual information such as a time of day, day of the week, time of year, and/or location in which the shared device 110 or screen 112 is being used.

The group token 512 may be provided or otherwise accessed by other modules of the system. More particularly, the group token 512 may be generated in a manner such that the other modules of the system can identify the individuals in the group. The group token may be encrypted to secure the identity of the members of the group and other group information from being accessed by other external systems. When one of the individuals 102-108 leaves the group or a new individual is added to the group, the group token 512 may be modified or a new group token may be generated.

The group token 512 may be associated with a group profile, as discussed above. The group profile may be generated by the authentication module 510 and/or other system module(s). The group profile may be generated based, at least in part, upon at least one user profile of each of the individuals 102-108 in the group. More particularly, the group profile may indicate characteristics of each of the individuals in the group and/or the group as a whole. In some implementations, the group profile may define the common denominator of the group. For example, the group profile may indicate that the youngest individual in the group is 12 years old. The group profile may also include or be associated with a targeting profile, a set of targeting rules, a privacy profile, and/or a set of privacy rules, as will be described in further detail below.

The authentication module 510 may provide the group token 512 associated with the group of individuals 102-108 and/or the group profile for use by application(s) of the web site 506. In some embodiments, this may be accomplished by providing the group token 512 and storing the group profile associated with the group token 512 in the cloud 534. In addition, the group token 512 and/or group profile may be provided at 514 to a privacy model generator 516 and/or a targeting model generator 518.

The privacy model generator 516 may retrieve the privacy profile and/or set of privacy rules for the group (e.g., from data store(s) or via the cloud 534) by accessing the group token 512. Moreover, the privacy model generator 516 may update the privacy profile and/or the set of privacy rules for the group based, at least in part, upon the group profile and/or user profile(s). Where a privacy profile or a set of privacy rules 520 has not yet been generated for the group, the privacy model generator 516 may generate a privacy profile and/or a set of privacy rules 520 based, at least in part, upon the group profile (or user profile(s) of the individuals in the group). For example, the set of privacy rules 520 may indicate that electronic mail messages directed to the individuals not be presented to the group. In some embodiments, the privacy model generator 516 may obtain privacy preferences from the group profile and/or user profile(s), which may be used to generate the privacy profile and/or set of privacy rules. The privacy profile may include various privacy settings, which may be set for the group or only specific users. For example, the privacy profile may indicate that electronic mail messages for the daughter Kathy be presented to the group, while electronic mail messages directed to other group members not be presented to the group.

The privacy profile and/or the set of privacy rules (or a portion thereof) may be provided to the targeting model generator 518 and/or content systems 522. Similarly, the targeting model generator 518 may retrieve a targeting profile and/or a set of targeting rules for the group (e.g., from data store(s) or via the cloud 534) by accessing the group token 512. In addition, the targeting model generator 518 may update the targeting profile and/or the set of targeting rules for the group based, at least in part, upon the group profile and/or user profile(s). Where the targeting profile and/or the set of targeting rules has not yet been generated for the group, the targeting model generator 518 may generate a targeting profile and/or a set of targeting rules based, at least in part, upon the group profile (or user profile(s) of the individuals in the group). More particularly, the targeting model generator 518 may generate the targeting profile and/or the set of targeting rules based upon profile information such as interests of the individuals of the group, the age(s) of the individuals in the group, gender(s) of the individuals in the group, and/or home or work addresses of the individuals in the group. For example, the targeting profile may indicate that this is a family-oriented session, and that the interests for this group of individuals include romantic vacations, family movies, Italian restaurants, rock music, and weekend travel. Thus, the set of targeting rules may indicate that violent advertisements should not be shown to this group. In some implementations, the privacy profile and/or the set of privacy rules (or portion thereof) may impact the generation of the targeting profile and/or the set of targeting rules.

The targeting profile and/or the set of targeting rules (or a portion thereof) may be provided to the content systems 522 and/or ad systems 528, as shown at 524 and 526, respectively. More particularly, the targeting profile and/or the set of targeting rules may be applicable to both content and advertising. Alternatively, a first portion of the targeting profile and/or the set of targeting rules may be applicable to identifying content suitable for the group, while a second portion of the targeting profile and/or the set of targeting rules may be applicable to identifying advertisements suitable for the group.

As shown in this example, the privacy model generator 516 and/or the targeting model generator 518 may be communicatively coupled to cloud 534, enabling the targeting profile, the set of targeting rules, the privacy profile, and/or the set of privacy rules to be retrieved, updated, stored and/or distributed among components of the system for use during the current and future sessions. In addition, the privacy model generator 516 may access user profiles of the individuals in the group via the cloud 534, enabling the privacy model generator 516 to generate the privacy profile and/or the privacy rules for the group. In some embodiments, user profile(s) of the individuals 102-108 in the group may establish privacy settings for scenarios such as electronic mail messages or text messages that are received when the individuals 102-108 are logged in as members of a group. Thus, the privacy profile and/or set of privacy rules may be automatically generated, at least in part, according to privacy settings of the individuals in the group. For example, the privacy profile and/or the set of privacy rules may be automatically generated, at least in part, according to the privacy settings of the individual having the most conservative privacy settings. As a result, individuals may be incentivized to login their friends and family members to protect their individual privacy. Similarly, the targeting model generator 518 may access the user profiles of the individuals in the group via the cloud 534, enabling the targeting model generator 518 to generate the targeting profile and/or the set of targeting rules for the group. For example, the user profiles may indicate interests of the individuals, historical online behavior of the individuals, and/or other information that may be pertinent to the generation of the set of targeting rules and/or the set of privacy rules. The privacy model generator 516 and/or the targeting model generator 518 may update the group profile according to information retrieved from the user profiles, the targeting profile and/or targeting rules that have been generated, and/or the privacy profile and/or privacy rules that have been generated. The group profile may be distributed and/or may be stored to data store(s) (or the cloud 534).

The content systems 522 may identify customized content including one or more content items suitable for the group based, at least in part, upon 1) the targeting profile and/or the set of targeting rules 524 and/or 2) the privacy profile and/or the set of privacy rules 520. For example, the content systems 522 may identify customized movie recommendations for the group. In some instances, the privacy profile and/or the set of privacy rules may prevent various content items from being provided to the group. Stated another way, the privacy profile and/or the set of privacy rules may act as a filter to ensure that various content items such as electronic messages are not presented to the group. The customized content or identification thereof may be provided at 530 to an application of the web site for transmission of the content items to the shared device 110.

Similarly, the ad systems 528 may identify customized advertisement(s) including one or more advertisements suitable for the group based, at least in part, upon the set of targeting rules 526. The customized advertisement(s) or identification thereof may be provided at 532 to an application of the web site for transmission of the advertisement(s) to the shared device 110.

Since the group is identified by the group token, it is possible to track the online behavior and interests of the group. For example, it is possible to track those movies that the group watches or adds to its viewing queue. As another example, it is possible to track categories of news articles or topics that are of particular interest to the group. Since a group often behaves differently from an individual, it is possible to track the behavior of the group separately from the behavior of the individuals. Accordingly, online behavior of the group is not attributed to an individual and vice versa.

The group profile may be updated to reflect the online behavior and/or interests of the group. More particularly, characteristics of the group behavior, interests of the group, and/or analysis thereof may be recorded in the group profile. In addition, the group profile may be updated to record group interaction patterns within the group via the shared device. The group profile may therefore be used to further refine the processing of the privacy model generator 516 and/or the targeting model generator 518. For example, a machine learning algorithm may be updated using the group profile for the group. Moreover, the targeting model generator 518 may refine the targeting profile and/or set of targeting rules for the group based upon the online behavior and/or interests of the group.

In view of the above, ad campaigns may be targeted to scenarios in which a group of two or more users are concurrently sharing the same device or screen. In addition, contextual advertisements may be designed or targeted to contexts in which two or more individuals are concurrently viewing the advertisements. In other words, advertisements may be designed or targeted to contexts in which an individual is in the presence of another individual.

Network

A network may couple devices so that communications may be exchanged, such as between a server and a client device or other types of devices, including between wireless devices coupled via a wireless network, for example. A network may also include mass storage, such as network attached storage (NAS), a storage area network (SAN), or other forms of computer or machine readable media, for example. A network may include the Internet, one or more local area networks (LANs), one or more wide area networks (WANs), wire-line type connections, wireless type connections, or any combination thereof. Likewise, sub-networks, such as may employ differing architectures or may be compliant or compatible with differing protocols, may interoperate within a larger network. Various types of devices may, for example, be made available to provide an interoperable capability for differing architectures or protocols. As one illustrative example, a router may provide a link between otherwise separate and independent LANs.

A communication link or channel may include, for example, analog telephone lines, such as a twisted wire pair, a coaxial cable, full or fractional digital lines including T1, T2, T3, or T4 type lines, Integrated Services Digital Networks (ISDNs), Digital Subscriber Lines (DSLs), wireless links including satellite links, or other communication links or channels, such as may be known to those skilled in the art. Furthermore, a computing device or other related electronic devices may be remotely coupled to a network, such as via a telephone line or link, for example.

Content Distribution Network

A distributed system may include a content distribution network. A “content delivery network” or “content distribution network” (CDN) generally refers to a distributed content delivery system that comprises a collection of computers or computing devices linked by a network or networks. A CDN may employ software, systems, protocols or techniques to facilitate various services, such as storage, caching, communication of content, or streaming media or applications. Services may also make use of ancillary technologies including, but not limited to, “cloud computing,” distributed storage, DNS request handling, provisioning, signal monitoring and reporting, content targeting, personalization, or business intelligence. A CDN may also enable an entity to operate or manage another's site infrastructure, in whole or in part.

Peer-to-Peer Network

A peer-to-peer (or P2P) network may employ computing power or bandwidth of network participants in contrast with a network that may employ dedicated devices, such as dedicated servers, for example; however, some networks may employ both as well as other approaches. A P2P network may typically be used for coupling nodes via an ad hoc arrangement or configuration. A peer-to-peer network may employ some nodes capable of operating as both a “client” and a “server.”

Wireless Network

A wireless network may couple client devices with a network. A wireless network may employ stand-alone ad-hoc networks, mesh networks, Wireless LAN (WLAN) networks, cellular networks, or the like.

A wireless network may further include a system of terminals, gateways, routers, or the like coupled by wireless radio links, or the like, which may move freely, randomly or organize themselves arbitrarily, such that network topology may change, at times even rapidly. A wireless network may further employ a plurality of network access technologies, including Long Term Evolution (LTE), WLAN, Wireless Router (WR) mesh, or 2nd, 3rd, or 4th generation (2G, 3G, or 4G) cellular technology, or the like. Network access technologies may enable wide area coverage for devices, such as client devices with varying degrees of mobility, for example.

For example, a network may enable RF or wireless type communication via one or more network access technologies, such as Global System for Mobile communication (GSM), Universal Mobile Telecommunications System (UMTS), General Packet Radio Services (GPRS), Enhanced Data GSM Environment (EDGE), 3GPP Long Term Evolution (LTE), LTE Advanced, Wideband Code Division Multiple Access (WCDMA), Bluetooth, 802.11b/g/n, or the like. A wireless network may include virtually any type of wireless communication mechanism by which signals may be communicated between devices, such as a client device or a computing device, between or within a network, or the like.

Internet Protocol

Signal packets communicated via a network, such as a network of participating digital communication networks, may be compatible with or compliant with one or more protocols. Signaling formats or protocols employed may include, for example, TCP/IP, UDP, DECnet, NetBEUI, IPX, Appletalk, or the like. Versions of the Internet Protocol (IP) may include IPv4 or IPv6.

The Internet refers to a decentralized global network of networks. The Internet includes LANs, WANs, wireless networks, or long haul public networks that, for example, allow signal packets to be communicated between LANs. Signal packets may be communicated between nodes of a network, such as, for example, to one or more sites employing a local network address. A signal packet may, for example, be communicated over the Internet from a user site via an access node coupled to the Internet. Likewise, a signal packet may be forwarded via network nodes to a target site coupled to the network via a network access node, for example. A signal packet communicated via the Internet may, for example, be routed via a path of gateways, servers, etc. that may route the signal packet in accordance with a target address and availability of a network path to the target address.

Social Network

The term “social network” refers generally to a network of individuals, such as acquaintances, friends, family, colleagues, or co-workers, coupled via a communications network or via a variety of sub-networks. Potentially, additional relationships may subsequently be formed as a result of social interaction via the communications network or sub-networks. A social network may be employed, for example, to identify additional connections for a variety of activities, including, but not limited to, dating, job networking, receiving or providing service referrals, content sharing, creating new associations, maintaining existing associations, identifying potential activity partners, performing or supporting commercial transactions, or the like.

A social network may include individuals with similar experiences, opinions, education levels or backgrounds. Subgroups may exist or be created according to user profiles of individuals, for example, in which a subgroup member may belong to multiple subgroups. An individual may also have multiple “1:few” associations within a social network, such as for family, college classmates, or co-workers.

An individual's social network may refer to a set of direct personal relationships or a set of indirect personal relationships. A direct personal relationship refers to a relationship for an individual in which communications may be individual to individual, such as with family members, friends, colleagues, co-workers, or the like. An indirect personal relationship refers to a relationship that may be available to an individual with another individual although no form of individual to individual communication may have taken place, such as a friend of a friend, or the like. Different privileges or permissions may be associated with relationships in a social network. A social network also may generate relationships or connections with entities other than a person, such as companies, brands, or so called ‘virtual persons.’ An individual's social network may be represented in a variety of forms, such as visually, electronically or functionally. For example, a “social graph” or “socio-gram” may represent an entity in a social network as a node and a relationship as an edge or a link.

Multi-Modal Communication (MMC)

Individuals within one or more social networks may interact or communicate with other members of a social network via a variety of devices. Multi-modal communication technologies refers to a set of technologies that permit interoperable communication across multiple devices or platforms, such as cellphones, smart phones, tablet computing devices, personal computers, televisions, SMS/MMS, email, instant messenger clients, forums, social networking sites (such as Facebook, Twitter, or Google), or the like.

Network Architecture

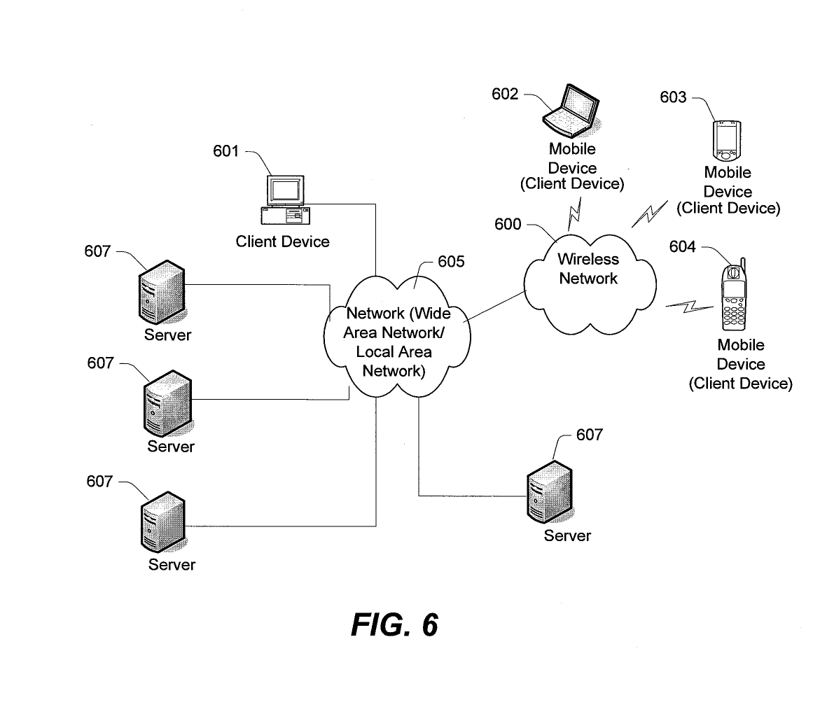

The disclosed embodiments may be implemented in any of a wide variety of computing contexts. FIG. 6 is a schematic diagram illustrating an example embodiment of a network. Other embodiments that may vary, for example, in terms of arrangement or in terms of type of components, are also intended to be included within claimed subject matter. Implementations are contemplated in which users interact with a diverse network environment. As shown in FIG. 6, for example, a network may include a variety of networks, such as a LAN/WAN 605 and wireless network 600, a variety of devices, such as client devices 601-604, and one or more servers 607 such as search server(s), content server(s), and/or ad server(s). As shown in this example, the client devices 601-604 may include one or more mobile devices 602, 603, 604. Client device(s) 601-604 may be implemented, for example, via any type of computer (e.g., desktop, laptop, tablet, etc.), media computing platforms (e.g., cable and satellite set top boxes), handheld computing devices (e.g., PDAs), cell phones, or any other type of computing or communication platform.

The enhancement of the experience of a group of individuals concurrently using a shared device may be performed in some centralized manner. This is represented in FIG. 6 by server(s) 607, which may correspond to multiple distributed devices and data store(s). One or more of the server(s) 607 may operate to serve content (e.g., news articles) and/or advertisements in accordance with the disclosed embodiments. In addition, the server(s) 607 and/or corresponding data store(s) may store user account data such as user profiles, other user information, and/or group information. For example, the group information may include group profiles and group tokens. The group profiles may indicate group characteristics (e.g., interests, preferences, and/or demographics), group privacy rules, and/or group targeting rules.

Server

A computing device may be capable of sending or receiving signals, such as via a wired or wireless network, or may be capable of processing or storing signals, such as in memory as physical memory states, and may, therefore, operate as a server. Thus, devices capable of operating as a server may include, as examples, dedicated rack-mounted servers, desktop computers, laptop computers, set top boxes, integrated devices combining various features, such as two or more features of the foregoing devices, or the like.

Servers may vary widely in configuration or capabilities, but generally a server may include one or more central processing units and memory. A server may also include one or more mass storage devices, one or more power supplies, one or more wired or wireless network interfaces, one or more input/output interfaces, or one or more operating systems, such as Windows Server, Mac OS X, Unix, Linux, FreeBSD, or the like.

Content Server

A content server may comprise a device that includes a configuration to provide content via a network to another device. A content server may, for example, host a site, such as a social networking site, examples of which may include, without limitation, Flicker, Twitter, Facebook, LinkedIn, or a personal user site (such as a blog, vlog, online dating site, etc.). A content server may also host a variety of other sites, including, but not limited to business sites, educational sites, dictionary sites, encyclopedia sites, wikis, financial sites, government sites, etc.

A content server may further provide a variety of services that include, but are not limited to, web services, third-party services, audio services, video services, email services, instant messaging (IM) services, SMS services, MMS services, FTP services, voice over IP (VOIP) services, calendaring services, photo services, or the like. Examples of content may include text, images, audio, video, or the like, which may be processed in the form of physical signals, such as electrical signals, for example, or may be stored in memory, as physical states, for example.

Examples of devices that may operate as a content server include desktop computers, multiprocessor systems, microprocessor-type or programmable consumer electronics, etc.

Client Device

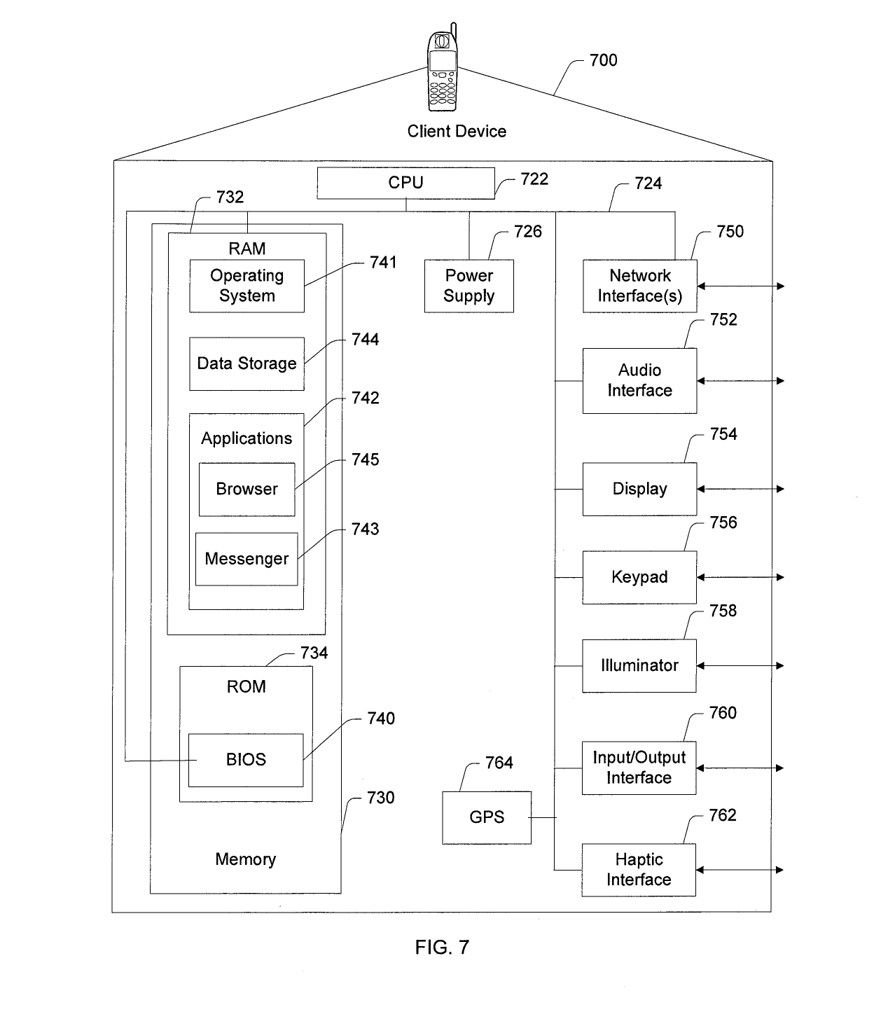

FIG. 7 is a schematic diagram illustrating an example embodiment of a client device that may operate as a shared device in accordance with various embodiments. For example, a user may submit a request such as an account request pertaining to his or her account, or another account, via a client device. A client device may include a computing device capable of sending or receiving signals, such as via a wired or a wireless network. A client device may, for example, include a desktop computer or a portable device, such as a cellular telephone, a smart phone, a display pager, a radio frequency (RF) device, an infrared (IR) device, a Personal Digital Assistant (PDA), a handheld computer, a tablet computer, a laptop computer, a set top box, a wearable computer, an integrated device combining various features, such as features of the forgoing devices, or the like.

As shown in this example, a client device 700 may include one or more central processing units (CPUs) 722, which may be coupled via connection 724 to a power supply 726 and a memory 730. The memory 730 may include random access memory (RAM) 732 and read only memory (ROM) 734. The ROM 734 may include a basic input/output system (BIOS) 740.

The RAM 732 may include an operating system 741. More particularly, a client device may include or may execute a variety of operating systems, including a personal computer operating system, such as a Windows, iOS or Linux, or a mobile operating system, such as iOS, Android, or Windows Mobile, or the like. The client device 700 may also include or may execute a variety of possible applications 742 (shown in RAM 732), such as a client software application such as messenger 743, enabling communication with other devices, such as communicating one or more messages, such as via email, short message service (SMS), or multimedia message service (MMS), including via a network, such as a social network, including, for example, Facebook, LinkedIn, Twitter, Flickr, or Google, to provide only a few possible examples. The client device 700 may also include or execute an application to communicate content, such as, for example, textual content, multimedia content, or the like, which may be stored in data storage 744. A client device may also include or execute an application such as a browser 745 to perform a variety of possible tasks, such as browsing, searching, playing various forms of content, including locally stored or streamed video, or games (such as fantasy sports leagues).

The client device 700 may send or receive signals via one or more interface(s). As shown in this example, the client device 700 may include one or more network interfaces 750. The client device 700 may include an audio interface 752. In addition, the client device 700 may include a display 754 and an illuminator 758. The client device 700 may further include an Input/Output interface 760, as well as a Haptic Interface 762 supporting tactile feedback technology.

The client device 700 may vary in terms of capabilities or features. Claimed subject matter is intended to cover a wide range of potential variations. For example, a cell phone may include a keypad such 756 such as a numeric keypad or a display of limited functionality, such as a monochrome liquid crystal display (LCD) for displaying text. In contrast, however, as another example, a web-enabled client device may include one or more physical or virtual keyboards, mass storage, one or more accelerometers, one or more gyroscopes, global positioning system (GPS) 764 or other location identifying type capability, or a display with a high degree of functionality, such as a touch-sensitive color 2D or 3D display, for example. The foregoing is provided to illustrate that claimed subject matter is intended to include a wide range of possible features or capabilities.

According to various embodiments, input may be obtained using a wide variety of techniques. For example, input for downloading or launching an application may be obtained via a graphical user interface from a user's interaction with a local application such as a mobile application on a mobile device, web site or web-based application or service and may be accomplished using any of a variety of well-known mechanisms for obtaining information from a user. However, it should be understood that such methods of obtaining input from a user are merely examples and that input may be obtained in many other ways.

Regardless of the system's configuration, it may employ one or more memories or memory modules configured to store data, program instructions for the general-purpose processing operations and/or the inventive techniques described herein. The program instructions may control the operation of an operating system and/or one or more applications, for example. The memory or memories may also be configured to store instructions for performing the disclosed methods, graphical user interfaces to be displayed in association with the disclosed methods, etc.

Because such information and program instructions may be employed to implement the systems/methods described herein, the disclosed embodiments relate to machine readable media that include program instructions, state information, etc. for performing various operations described herein. Examples of machine-readable media include, but are not limited to, magnetic media such as hard disks, floppy disks, and magnetic tape; optical media such as CD-ROM disks; magneto-optical media such as optical disks; and hardware devices that are specially configured to store and perform program instructions, such as ROM and RAM. Examples of program instructions include both machine code, such as produced by a compiler, and files containing higher level code that may be executed by the computer using an interpreter.

Computer program instructions with which various embodiments are implemented may be stored in any type of computer-readable media, and may be executed according to a variety of computing models including a client/server model, a peer-to-peer model, on a stand-alone computing device, or according to a distributed computing model in which various of the functionalities described herein may be effected or employed at different locations.

The disclosed techniques may be implemented in any suitable combination of software and/or hardware system, such as a web-based server or desktop computer system. Moreover, a system implementing various embodiments may be a portable device, such as a laptop or cell phone. An apparatus and/or web browser may be specially constructed for the required purposes, or it may be a general-purpose computer selectively activated or reconfigured by a computer program and/or data structure stored in the computer. The processes presented herein are not inherently related to any particular computer or other apparatus. In particular, various general-purpose machines may be used with programs written in accordance with the teachings herein, or it may be more convenient to construct a more specialized apparatus to perform the disclosed method steps.

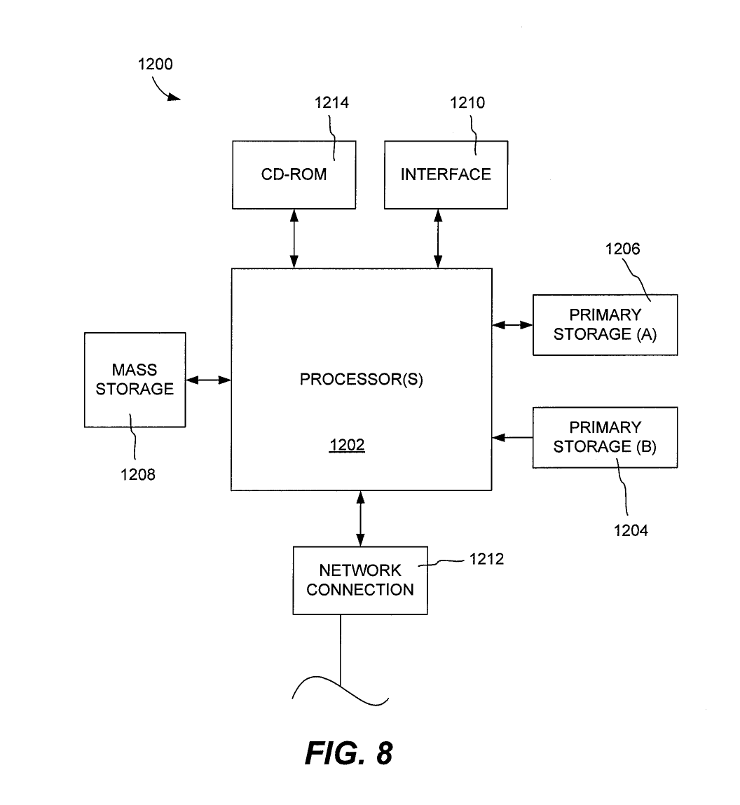

FIG. 8 illustrates a typical computer system that, when appropriately configured or designed, can serve as a system via which various embodiments may be implemented. The computer system 1200 includes any number of CPUs 1202 that are coupled to storage devices including primary storage 1206 (typically a RAM), primary storage 1204 (typically a ROM). CPU 1202 may be of various types including microcontrollers and microprocessors such as programmable devices (e.g., CPLDs and FPGAs) and unprogrammable devices such as gate array ASICs or general purpose microprocessors. As is well known in the art, primary storage 1204 acts to transfer data and instructions uni-directionally to the CPU and primary storage 1206 is used typically to transfer data and instructions in a bi-directional manner. Both of these primary storage devices may include any suitable computer-readable media such as those described above. A mass storage device 1208 is also coupled bi-directionally to CPU 1202 and provides additional data storage capacity and may include any of the computer-readable media described above. Mass storage device 1208 may be used to store programs, data and the like and is typically a secondary storage medium such as a hard disk. It will be appreciated that the information retained within the mass storage device 1208, may, in appropriate cases, be incorporated in standard fashion as part of primary storage 1206 as virtual memory. A specific mass storage device such as a CD-ROM 1214 may also pass data uni-directionally to the CPU.

CPU 1202 may also be coupled to an interface 1210 that connects to one or more input/output devices such as such as video monitors, track balls, mice, keyboards, microphones, touch-sensitive displays, transducer card readers, magnetic or paper tape readers, tablets, styluses, voice or handwriting recognizers, or other well-known input devices such as, of course, other computers. Finally, CPU 1202 optionally may be coupled to an external device such as a database or a computer or telecommunications network using an external connection as shown generally at 1212. With such a connection, it is contemplated that the CPU might receive information from the network, or might output information to the network in the course of performing the method steps described herein.

Although the foregoing embodiments have been described in some detail for purposes of clarity of understanding, it will be apparent that certain changes and modifications may be practiced within the scope of the appended claims. Therefore, the present embodiments are to be considered as illustrative and not restrictive, and are not to be limited to the details given herein, but may be modified within the scope and equivalents of the appended claims.

What is claimed is:

1. A method, comprising:
identifying a group of two or more individuals;
obtaining a group profile associated with the group of two or more individuals;
identifying one or more content items and/or one or more advertisements suitable for presenting to the group of two or more individuals based, at least in part, upon the group profile; and
providing the one or more content items and/or one or more advertisements to the group of two or more individuals.

2. The method of claim 1, wherein the group of two or more individuals concurrently accesses a shared screen of a shared device, wherein the one or more content items and/or advertisements are provided to the shared device.

3. The method of claim 1, wherein identifying the group of two or more individuals comprises obtaining or generating a group token associated with the group of two or more individuals.

4. The method of claim 1, wherein identifying the group of two or more individuals comprises:
receiving identification information of at least one of the two or more individuals in the group of two or more individuals.

5. The method of claim 1, wherein obtaining a group profile comprises:
generating the group profile, at least in part, from a user profile of each of the two or more individuals in the group of two or more individuals.

6. The method of claim 1, further comprising:
obtaining a set of group preferences associated with the group of two or more individuals;
wherein the group profile is generated or modified according to the set of group preferences.

7. The method of claim 6, wherein the set of group preferences is indicated, selected, or specified by a group leader of the group of two or more individuals.

8. The method of claim 1, further comprising:
receiving an indication that at least one of 1) one of the two or more individuals is leaving or has left the group of two or more individuals or 2) an individual has joined or is joining the group of two or more individuals; and
generating, modifying or retrieving the group profile according to the indication to reflect at least one of 1) that the one of the two or more individuals is no longer in the group of two or more individuals or 2) an individual has joined or is joining the group of two or more individuals.

9. The method of claim 1, wherein the group profile indicates characteristics of the group of two or more individuals.

10. The method of claim 1, wherein the group profile defines a common denominator of the group of two or more individuals.

11. The method of claim 1, wherein the group profile comprises a targeting profile and/or a set of one or more targeting rules for identifying content or advertisements suitable for presenting to the group of two or more individuals.

12. The method of claim 1, wherein the group profile comprises a privacy profile and/or a set one or more privacy rules for providing content addressed to a single individual in the group of two or more individuals to the group of two or more individuals.

13. The method of claim 1, further comprising:
tracking behavior of the group of two or more individuals; and
recording characteristics of the behavior of the group of two or more individuals such that the group profile is updated based, at least in part, upon the characteristics.

14. The method of claim 13, wherein identifying one or more content items and/or one or more advertisements suitable for presenting to the group of two or more individuals is performed based, at least in part, upon the characteristics of the behavior of the group of two or more individuals.

15. An apparatus, comprising:
one or more processors; and
one or more memories, at least one of the processors or memories being configured for:
identifying a group of two or more individuals;
obtaining a group profile associated with the group of two or more individuals;
identifying one or more content items and/or one or more advertisements suitable for presenting to the group of two or more individuals based, at least in part, upon the group profile; and
providing the one or more content items and/or the one or more advertisements for access by the group of two or more individuals.

16. The apparatus of claim 15, wherein the group of two or more individuals accesses a shared screen of a shared device, and wherein the one or more content items and/or advertisements are provided to the shared device.

17. The apparatus of claim 15, wherein the group profile comprises a set of one or more targeting rules for identifying content or advertisements suitable for presenting to the group of two or more individuals.

18. The apparatus of claim 15, wherein the group profile comprises a set one or more privacy rules for providing content addressed to a single individual in the group of two or more individuals.

19. At least one non-transitory computer-readable medium storing thereon computer-readable instructions, comprising:
instructions for identifying a group of two or more individuals;
instructions for obtaining a group profile associated with the group of two or more individuals;
instructions for identifying one or more content items and/or one or more advertisements suitable for presenting to the group of two or more individuals based, at least in part, upon the group profile; and
instructions for providing the one or more content items and/or advertisements for access by the group of two or more individuals.

20. The at least one non-transitory computer-readable medium of claim 19, wherein the group of two or more individuals accesses a shared screen of a shared device, and wherein the one or more content items and/or advertisements are provided to the shared device.
